(19) United States
(12) Patent Application Publication
(10) Pub. No.: US 2013/0026332 A1
(43) Pub. Date: Jan. 31, 2013

(54) FIXING DEVICE FOR FAN

(71) Applicant: LEI LIU, Shenzhen City (CN)

(72) Inventor: LEI LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/197,773

(22) Filed: Aug. 4, 2011

(30) Foreign Application Priority Data
Jul. 25, 2011 (CN) 201110208602.2

(51) Int. Cl. F16M 13/00

(52) U.S. Cl. 248/674

(57) ABSTRACT

A device for fixing one or more fans includes a rack and a board pivotably mounted to the rack. The rack defines one or more vents. A number of protrusions protrude from the rack around the vent to locate one end of each fan; a pivoting blocking plate comes down onto the other end of the fan to hold it firmly in place.

### BACKGROUND

1. Technical Field

The present disclosure relates to a device for fixing a plurality of fans.

2. Description of Related Art

Generally, electronic devices use fans to cool electronic components. Conventionally, a fan is mounted in the electronic device by a plurality of screws, which makes it difficult and time-consuming to replace or remove the fan for repair.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a fixing device and fans.

FIG. 2 is an enlarged view of the circled portion II of FIG. 1.

FIG. 3 is a partially assembled, isometric view of FIG. 1.

FIG. 4 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

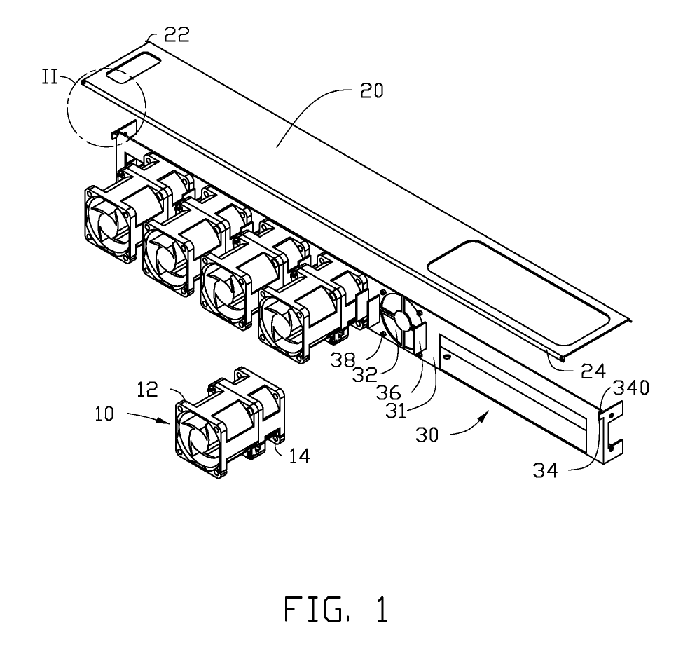

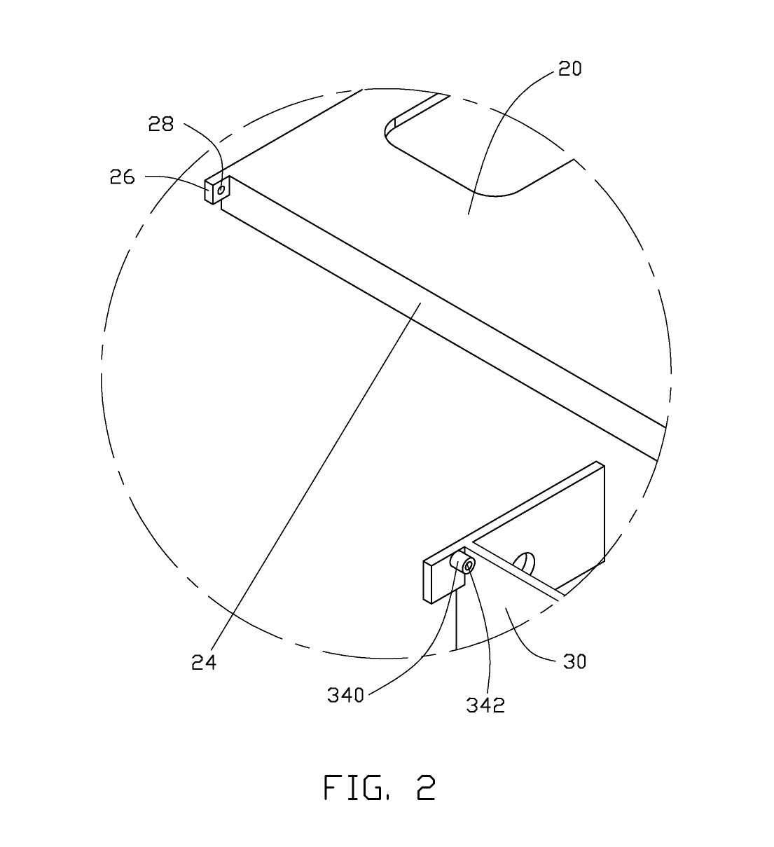

Referring to FIGS. 1 and 2, an exemplary embodiment of a fixing device for fixing a plurality of fan members 10 includes a board 20 and a rack 30 mounted to a chassis (not shown).

In this embodiment, each fan member 10 includes two fans connected side by side. The fan member 10 includes two end faces at either end (end boards 12) of the fan member 10. Each end board 12 defines four corner holes (engaging holes 140). In another embodiment, the fan member 10 may be one single fan.

The rack 30 includes a rectangular main body 31 longitudinally defining a plurality of vents 32. Two parallel fixing pieces 34 extend in a substantially perpendicular manner from the tops of opposite ends of the main body 31. Two plates 36 flanking each vent 32 extend in a substantially perpendicular manner from the main body 31. Four protrusions 38 protrude from the main body 31 around each vent 32, and correspond to the engaging holes 14. A circular protrusion 340 which axially defines a fixing hole 342 extends from the inner surface of each fixing piece 34.

The board 20 is rectangular. Two pins 22 extend outwards from opposite ends of the first side of the board 20. A blocking plate 24 extends in a substantially perpendicular manner along the second side of the board 20 opposite to the first side. Two tabs 26, each defining a through hole 28, extend in a substantially perpendicular manner from opposite ends of the blocking plate 24.

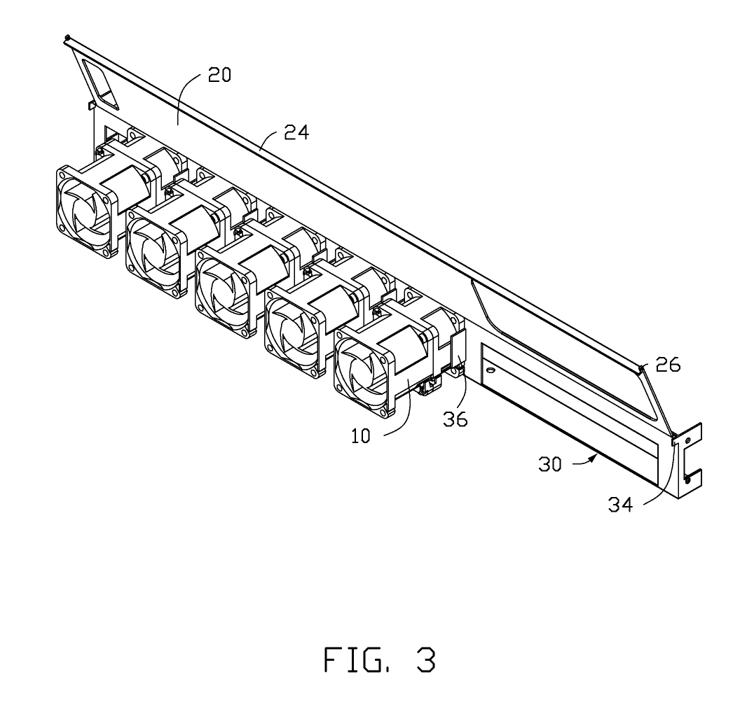

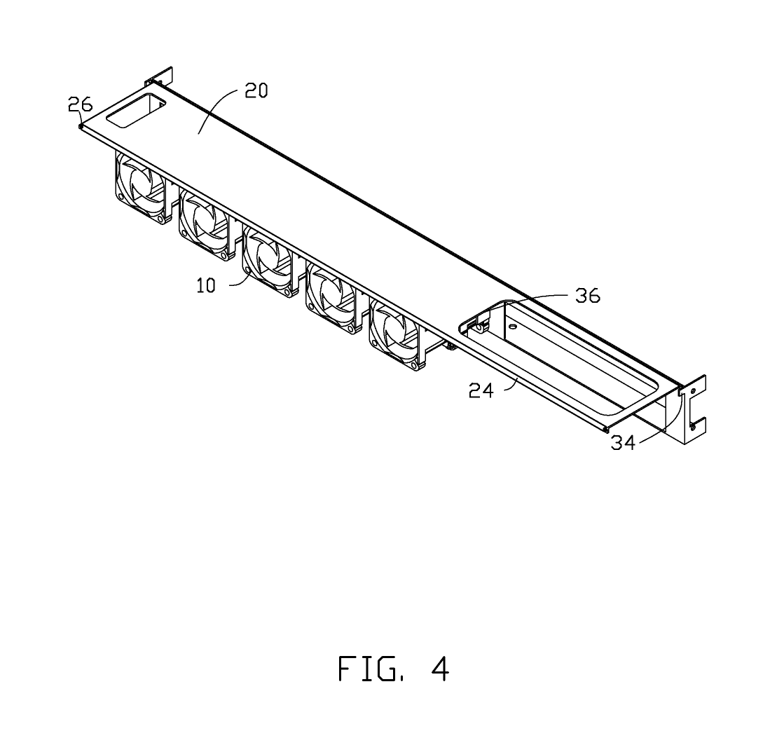

Referring to FIGS. 3 and 4, in assembly, the pins 22 are inserted into the fixing holes 342, to pivotably mount the board 20 to the rack 30.

In use, each fan member 10 is sandwiched between the plates 36 to align with a vent 32. The protrusions 38 are engaged in the engaging holes 14 of one of the end boards 12. The board 20 pivots downwards to lie across the fan member(s) 10. The blocking plate 24 abuts the other end board 12 of each fan member 10. Two screws (not shown) extend through the through holes 28 and engage in the chassis, to fix the board 20 to the chassis and thereby hold each fan member 10 in its respective place.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A fixing device for fixing a fan member with two opposite end boards, the fixing device comprising:
a rack defining a vent, a plurality of protrusions protrudes from the rack around the vent to engage in one of the end boards of the fan; and
a board pivotably mounted to the rack with a first side of the board, a blocking plate extending from a second side of the board opposite to the first side to abut the other end board of the fan.

2. The fixing device of claim 1, wherein two pins extend away from each other from opposite ends of the first side, two fixing pieces perpendicularly extend from opposite ends of the rack, each fixing piece defines a fixing hole to pivotably engage with one of the pins.

3. The fixing device of claim 2, wherein a protrusion extends from an inner surface of each fixing piece toward the other fixing piece, the protrusion defines a fixing hole therein.

4. The fixing device of claim 1, wherein two plates extend from the rack at opposite sides of the vent to sandwich the fan.
